(19) United States
(12) Patent Application Publication
(10) Pub. No.: US 2021/0392511 A1
(43) Pub. Date: Dec. 16, 2021

(54) USER EQUIPMENT (UE) MEASUREMENT TO ESTIMATE COVERAGE THRESHOLD

(71) Applicants: Kumar Balachandran, PLEASANTON, CA (US); Sailesh Bharati, STITTSVILLE (CA); Gary Boudreau, KANATA (CA); Virgil Cimpu, OTTAWA (CA); Chris Williams, NEPEAN (CA)

(72) Inventors: Kumar Balachandran, PLEASANTON, CA (US); Sailesh Bharati, STITTSVILLE (CA); Gary Boudreau, KANATA (CA); Virgil Cimpu, OTTAWA (CA); Chris Williams, NEPEAN (CA)

(21) Appl. No.: 17/282,060

(22) PCT Filed: Oct. 4, 2019
(86) PCT No.: PCT/IB2019/058490

§ 371 Date: Apr. 1, 2021

Related U.S. Application Data
(60) Provisional application No. 62/741,331, filed on Oct. 4, 2018.

(51) Int. Cl. H04W 16/18; H04W 16/14; H04W 24/02

(52) U.S. Cl. CPC H04W 16/18; H04W 24/02; H04W 16/14

(57) ABSTRACT

A network node of a communications network configured to provide Citizen Broadband Radio Service (CBRS) to at least one end user device (EUD) in a coverage area of the network node. The network node comprises: at least one processor; and a memory storing software instructions configured to control the at least one processor to perform steps of: causing the at least one EUD to report information indicative of a respective reference signal downlink power detected by the at least one EUD; and determine a respective coverage threshold for the network node based on the information reported by the at least one EUD.

### TECHNICAL FIELD

The present disclosure relates to wireless networks, and in particular to user equipment (UE) Measurement to Estimate Coverage Threshold.

### BACKGROUND

Citizen Broadband Radio Service (CBRS) is currently defined in Part 96 of Title 47, Chapter 1, Subchapter D of the United States Code of Federal Regulations. It is contemplated that successor regulations and technical standards may be defined in the future, and that counterpart services may become available outside the United States. CBRS offers spectrum at 3550-3700 MHz that may be shared with primary federal and commercial incumbents and Mobile Broadband (MBB) users in a novel three-tier approach in the United States of America. The CBRS uses a geolocation database and policy management function known as the Spectrum Access System (SAS) to manage the use of spectrum for MBB users. With such a tiered access, incumbent users (referred to as incumbents here after) are given highest priority to access the spectrum and are protected against interference from other devices/users that are using the CBRS band. Incumbents are federal entities that are primarily authorized to use the spectrum such as navy/military vessel and radar, commercial users that operate under terms available to the Fixed Satellite Service (FSS), or users of the Wireless Broadband Services (WBS) as defined under the FCC rules in 47 CFR part 90, subpart Z of the Code of Federal Regulations in the United States of America. WBS users are typically Wireless Internet Service Provider (WISP), and fixed microwave users operating under light licensing rules and are herewith referred to as grandfathered wireless users (GWU).

Radio transmission equipment operating as base stations that use the CBRS band are referred to as CBRS devices (CBSD). For the main systems under consideration, a CBSD may non-exclusively be an evolved Node B (eNB) as defined for the Long Term Evolution (LTE) standard or gNB as defined by the 3GPP NR standard, base station, access point, fixed microwave equipment or customer-premises equipment that uses the CBRS band. As per federal rules, user equipment or mobile terminal that are being served by CBSDs are referred to as End User Devices (EUD). Incumbents along with GWUs constitute the highest tier of the CBRS ecosystem and are worthy of protection from interference beyond a specified level. A GWU that is registered in the FCC Universal Licensing System is protected for five years within which they must seek to transition to qualify as CBSDs. Whenever incumbents' operations are not being interfered with, as defined in the FCC rules of 47 CFR Part 96, the SAS may authorize spectrum to be used by the lower tiers of the CBRS framework by allowing CBSDs to transmit in either the Priority Access (PA) tier or the General Authorized Access (GAA) tier. When a CBSD has a PA licenses (PAL), it will be protected against interference from other CBSDs authorized for PA or GAA. A GAA user does not generally qualify for any interference protection under the federal rules. However, it is largely recognized that the SAS may assume a role that accords GAA to use the greatest possible protection possible by enabling sharing under terms that are mutually acceptable among participating CBSDs. Such a role may include apportioning spectrum through methods that seek to mitigate interference through a variety of means such as division of spectrum, or interfaces to analysis engines known as co-existence managers (CxM) that seek to introduce more advanced coordination of transmission patterns and synchronization of networks on common timing references. The FCC has decreed that SASs may operate nationwide in a competitive approach to offer service to networks of CBSDs.

Thus, the SAS may manage co-existence between GAA CBSDs in a manner that improves spectrum utilization well beyond what is possible using white space rules. The SAS is aided in this endeavor by registering device characteristics for all CBSDs. These CBSDs register as one of two categories, Category A (Cat A) and Category B (Cat B) based on their power levels, and deployment characteristics. Indoor CBSDs are lower power Category A devices, while all devices having high radiated power levels or devices above 6 m height above average terrain (HAAT) register as Category B. CBSDs also register information about their transmission characteristics, antenna patterns, three-dimensional geolocation coordinates etc. The registration information allows the SAS to model propagation and interference statistics over the service area under analysis, potentially using information harvested from CBSD measurements. With the current proposals from standard development organizations, such as Wireless Innovation Forum (WInnForum) and CBRS Alliance (CBRS-A), it has been suggested that SAS may use a certain received power level for all the CBSD to determine the coverage area of a CBSD (such a threshold power level is referred to as a coverage threshold here after). The SAS further uses the calculated coverage area to determine if CBSDs co-exist without interfering or with acceptable interference to each other as well to incumbents.

### SUMMARY

An aspect of the present invention provides A network node of a communications network configured to provide Citizen Broadband Radio Service (CBRS) to at least one end user device (EUD) in a coverage area of the network node. The network node comprises at least one processor, and a memory storing software instructions configured to control the at least one processor to perform steps of: causing the at least one EUD to report information indicative of a respective reference signal downlink power detected by the at least one EUD; and determining a respective coverage threshold for the network node based on the information reported by the at least one EUD.

The techniques disclosed herein comprise a method in CBRS to determine the coverage threshold to be employed by a SAS/CxM or operator network itself that reflect the realistic transmission capability of a CBSD, instead of the SAS/CxM using an arbitrary threshold value for all the CBSDs under its control. Moreover, the present disclosure presents key elements that are useful to determine the coverage threshold that is needed for accurate and efficient operation of several CBRS related entities. These elements include:
Roles for entities such as CBSD and UE;
Application and analysis of parameters based on the received power of downlink reference signal and its histogram with details of how they can be generated. Note that parameters such as reference signal received power (RSRP), reference signal received quality (RSRQ), reference signal's signal to interference plus noise ratio (RS-SINR), and channel state information—reference signal (CSI-RS) can be used for this purpose; and
Procedures to:
   collect measurement reports;
   construct a histogram based on the collected measurement reports; and
   use the constructed histogram to determine a respective coverage threshold of a particular CBSD

Embodiments of a base station, communication system, and a method in a communication system are also disclosed.

### BRIEF DESCRIPTION OF THE DRAWINGS

The accompanying drawing FIG.s incorporated in and forming a part of this specification illustrate several aspects of the disclosure, and together with the description serve to explain principles of the disclosure.

FIG. 1 is a block diagram schematically illustrating a representative network in which embodiments of the present invention may be deployed;

FIGS. 2A and 2B are block diagrams schematically illustrating examples of a computing device usable in embodiments of the present invention;

FIG. 3 is a flow chart illustrating a representative process in accordance with an embodiment of the present invention;

FIG. 4 is a histogram constructed based on RSRP samples in accordance with an embodiment of the present invention; and

FIG. 5 is a histogram constructed based on RSRP samples in accordance with another embodiment of the present invention.

### DETAILED DESCRIPTION

The embodiments set forth below represent information to enable those skilled in the art to practice the embodiments and illustrate the best mode of practicing the embodiments. Upon reading the following description in light of the accompanying drawing FIG.s, those skilled in the art will understand the concepts of the disclosure and will recognize applications of these concepts not particularly addressed herein. It should be understood that these concepts and applications fall within the scope of the disclosure.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell;” however, particularly with respect to 5G NR concepts, beams may be used instead of cells and, as such, it is important to note that the concepts described herein are equally applicable to both cells and beams.

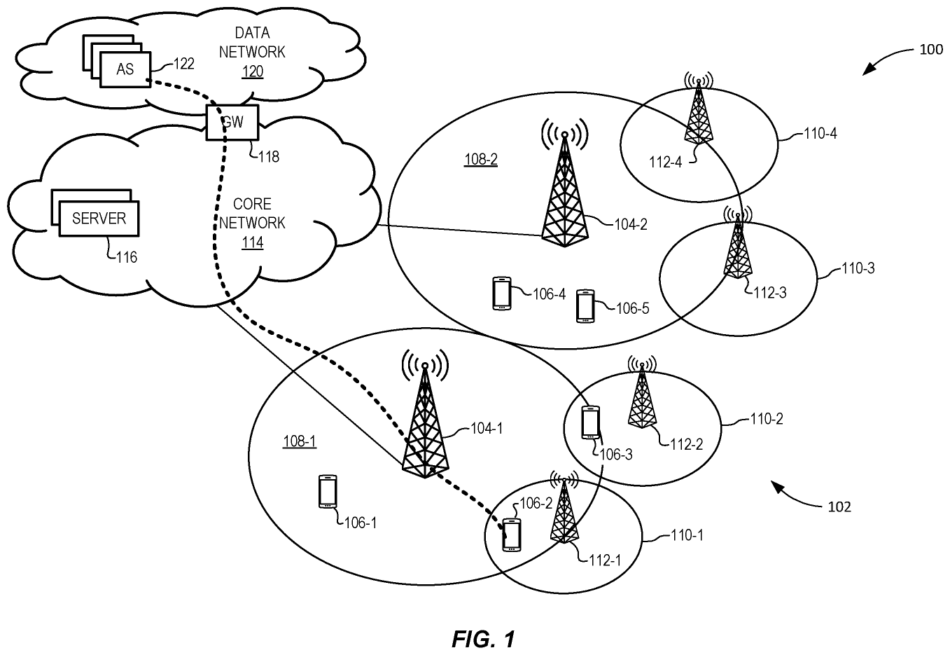

FIG. 1 illustrates one example of a cellular communications network 100 in which embodiments of the present disclosure may be implemented. In the embodiments described herein, the cellular communications network 100 is a Public Land Mobility Network (PLMN) conforming to one or more of the LTE, 3G, 4G and 5G NR standards, or their successors. In the illustrated example, the cellular communications network 100 includes a (Radio) Access Network ((R)AN) 102 comprising base stations 104-1 and 104-2 controlling radio communications with wireless devices 106-1, 106-2, 106-3, 106-4,106-5 within corresponding macro cells 108-1 and 108-2. Each macro cell 108 may be defined by any suitable combination of geography, frequency, Radio Access Technology (RAT) and modulation scheme.

Base stations 104 can be any type of network access device capable of establishing radio connection(s) with one or more wireless devices 106 within a respective coverage area of the base station 104 or low power node 112, and further configured to forward subscriber traffic between the core network 114 and the one or more wireless devices 106. An important feature of a base station 104 is that it is configured with both a radio interface configured to send and receive radio signals to and from a wireless device 106, and a network interface configured to exchange electronic and/or optical signals with the core network 114. Examples of base stations 104 and low power nodes 112 include: Evolved Node B (eNB) systems (known, for example, in the 3GPP standards): WiFi access points (known, for example from IEEE 802.11 standards) or the like. In some contexts, a base station 104 may be referred to as an access point (AP) regardless of the Radio Access Technology (RAT) that it supports. A base station 104 configured to use the Citizen Broadband Radio Service (CBRS) band (e.g. 3550-3700 MHz) may be referred to as a CBRS device (CBSD).

The illustrated (R)AN 102 also includes small cells 110-1 through 110-4, within which radio communication can be controlled by corresponding low power nodes 112-1 through 112-4. As with the macro cells 108, each small cell may be defined by any suitable combination of geography, frequency, Radio Access Technology (RAT) and modulation scheme. As with the base stations 104, a low power node 112 can be any type of network access device capable of establishing radio connection(s) with one or more wireless devices 106 within a respective coverage area of the low power node 112, and further configured to forward subscriber traffic between the core network 114 and the one or more wireless devices 106. An important feature of a low power node 112 is that it is configured with both a radio interface configured to send and receive radio signals to and from a wireless device 106, and a network interface configured to exchange electronic and/or optical signals with the core network 114. In some embodiments, a low power node 112 may be connected to the core network 114 by a direct connection, such as an optical cable. In other embodiments, a low power node 112 may be connected to the core network 114 by an indirect connection, such as via a radio or optical fiber link to a base station 104. Examples of low power nodes 112 include: Remote Radio Heads (RRHs) connected to a base station or a network router (not shown): WiFi access points or the like. In some contexts, a low power node 112 may be referred to as an access point (AP) regardless of the specific Radio Access Technology (RAT) that it supports. A low power node 112 configured to use the Citizen Broadband Radio Service (CBRS) band (e.g. 3550-3700 MHz) may also be referred to as a CBRS device (CBSD).

Notably, while not illustrated, a particular small cell 110 may alternatively be controlled by a base station 104, for example using a beam-forming technique. In such cases, the particular small cell 110 will not be associated with a respective low power node 112 per se. Rather, the particular small cell 110 will be associated with a respective set of parameters implemented in the base station 104. In this disclosure, the term “cell” is used to refer to a defined combination of parameters (such as geography, frequency, Radio Access Technology (RAT), modulation scheme, identifiers and the like) that can be used by a wireless device 106 to access communication services of the network 100. The term “cell” does not imply any particular parameter values, or any particular physical configuration of devices needed to enable a wireless device 106 to access those communication services.

Wireless devices 106 can be any type of device capable of sending and receiving radio signals to and from a base station 104 and/or low power node 112. Examples of wireless device 106 include cellular phones, Personal Data Assistants (PDAs), mobile computers, Internet of Things (IoT) devices, autonomous vehicle controllers, and the like. In some contexts, a wireless device 106 may be referred to as a User Equipment (UE), and End User Device (EUD) or a mobile device.

In some embodiments, the macro cells 108-1 and 108-2 may overlap each other, and may also overlap one or more small cells 110. For example, a particular macro cell 108-1 may be one macro cell 108 among a plurality of macro cells covering a common geographical region and having a common RAT and modulation scheme, but using respective different frequencies and/or AP identifiers. In such cases, a wireless device 106 located within a region covered by two or more overlapping cells 108, 112 may send and receive radio signals to and from each of the corresponding base stations 104 and/or low power nodes 112.

In the illustrated example, the (R)AN 102 is connected to a Core Network (CN) 114, which may also be referred to as Evolved Core Network (ECN) or Evolved Packet Core (EPC). The CN 114 includes (or, equivalently, is connected to) one or more servers 116 configured to provide networking services such as, for example, Network Functions (NFs) described in 3GPP TS 23.501 V15.2.0 (2018-06) “System Architecture for the 5G System” and its successors. The CN 114 also includes one or more gateway (GW) nodes 118 configured to connect the CN 114 to a packet data network (DN) 120 such as, for example, the internet. A gateway node 118 may be referred to as a packet gateway (PGW) and/or a serving gateway (SGW). The DN 120 may provide communications services to support end-to-end communications between wireless devices 106 and one or more application servers (aSs) 122 configured to exchange data packet flows with the wireless devices 106 via the CN 114 and (R)AN 102. In some contexts, an application server (AS) 122 may also be referred to as a host server.

In some contexts, an end-to-end signal path between an AS 122 and one or more wireless devices 106 may be referred to as an Over-The-Top (OTT) connection. Similarly, a communication service that employs signal transmission between an AS 122 and one or more wireless devices 106 may be referred to as an OTT service.

It should be appreciated that the separation between the CN 114 and the DN 120 can be purely logical, in order to simplify understanding of their respective roles. In particular, the CN 114 is primarily focused on providing wireless device access services and supporting wireless device mobility. On the other hand, the DN 120 is primarily focused on providing end-to-end communications, particularly across network domains. However, it will be appreciated that both the CN 114 and the DN 120 can be implemented on common physical network infrastructure, if desired.

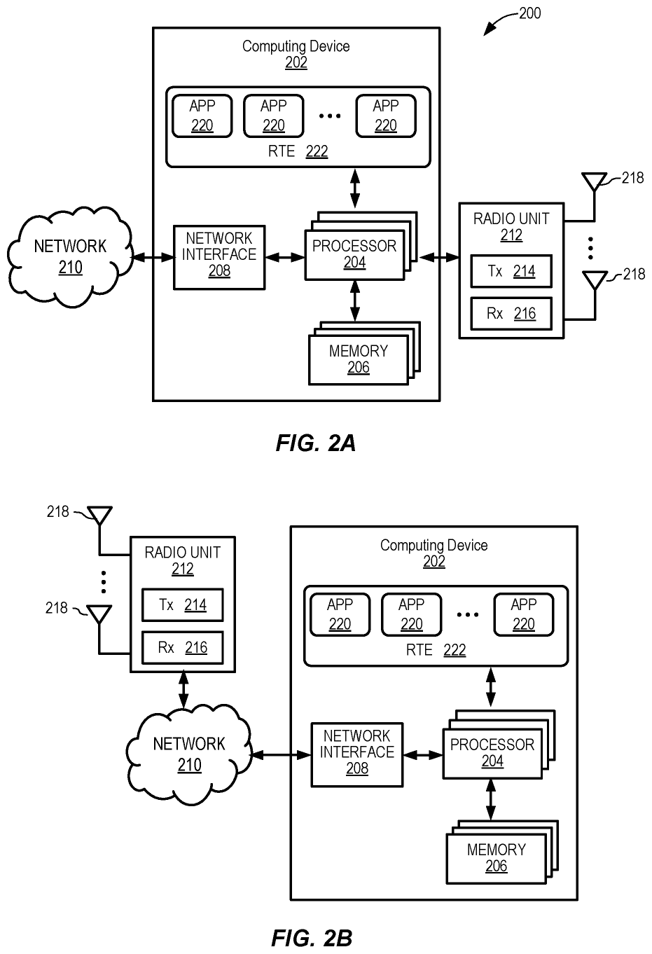

FIGS. 2A and 2B are block diagrams schematically illustrating a communications system 200 including a computing device 202 usable in embodiments of the present invention. In various embodiments, any or all of the base stations 104 or 112, wireless devices 106, core network servers 116 or gateways 118 and data network servers 122 may be implemented using systems and principles in accordance with the computing device 202. It may also be appreciated that any or all of the elements of the network 100 may be virtualized using techniques known in the art or developed in the future, in which case the functions of any or all the base stations 104 or 112, core network servers 116 or gateways 118, and/or any or all network functions of the RAN 102, CN 114 and DN 120 may be implemented by suitable software executing within a computing device 202 or within a data center (non shown) composed of multiple computing devices 202.

In the example of FIG. 2A, the communications system 200 generally includes computing device 202 connected to one or more networks 210 and one or more radio units 212. The computing device 202 includes one or more processors 204, a memory 206, one or more network interfaces 208. The processors 204 may be provided as any suitable combination of Central Processing Units (CPUs), Application Specific Integrated Circuits (ASICs), Field Programmable Gate Arrays (FPGAs), or the like. Similarly, the memory 206 may be provided as any suitable combination of Random Access Memory (RAM), Read Only Memory (ROM) and mass storage technologies such as magnetic or optical disc storage or the like. The network interfaces 208 enable signaling between the computing device 200 and the networks 210, such as the Core Network 114, the data network 120, or a private domain network such as a data center (not shown).

Each radio unit 212 typically includes at least one transmitter (Tx) 214 and at least one receiver (Rx) 216 coupled to one or more antennas 218. In the example of FIG. 2A, the radio unit(s) 212 is(are) shown as being external to the computing device 202 and connected to the computing device 202 via a suitable physical connection (such as a copper cable or an optical cable). In the example of FIG. 2B, the radio unit(s) 212 is(are) shown as being connected to computing device 202 via the network 210 and the network interface 208. In still other embodiments, the radio unit(s) 212 and optionally also the antenna(s) 218 may be integrated together with the computing device 202.

The one or more processors 204 operate to provide functions of the computing device 202. Typically, these function(s) are implemented as software applications (APPs) or modules 220 stored in the memory 206, for example, and executed by the one or more processors 304. In some embodiments, one or more software applications or modules 220 may execute within a secure run-time environment (RTE) 222 maintained by an operating system (not shown) of the computing device 202.

It may be appreciated that specific embodiments may exclude one or more of the elements illustrated in FIGS. 2A and 2B. For example, a computing device 202 configured to implement a wireless device 106 may incorporate one or more processors 204, a memory 206, and one or more radio units 212, but may exclude a network interface 208 and associated connections through the network 210. Conversely, a computing device 202 configured to implement a server 116 or 122 may include one or more processors 204, a memory 206, and one or more network interfaces 208, but may exclude radio units 212. A computing device 302 configured to implement a base station 104 or 112, on the other hand, will normally include one or more processors 204, a memory 206, and both radio units 212 and network interfaces 208.

A Spectrum Access System (SAS) normally estimates the coverage area of a CBSD, using reference propagation models and an arbitrary coverage threshold value for all the CBSDs under its control. It may then declare that two CBSDs are interfering with each other if their coverages overlap. Moreover, the SAS may select the coverage threshold in such a way that the co-existence operations are tractable with the given number and distribution of CBSDs for the selected coverage threshold. However, it is possible that all the CBSDs may not have the same transmission and reception capabilities, thus assigning the same coverage threshold for all the CBSDs may not be accurate. Thus, conventional SAS operations based on such an arbitrary coverage threshold may not always reflect a realistic scenario, and may result in an incorrect pathloss and interference calculations. Furthermore, it may negatively affect allocation of spectrum and power to the CBSDs and in general to the co-existence operations. Thus, it is desirable to provide a mechanism to accurately estimate the coverage threshold for each CBSD, which can further be used to optimize GAA co-existence in the CBRS band.

This disclosure presents a set of systems and mechanisms which enables a CBSD to estimate its coverage threshold, which is defined based on the downlink (DL) received power at the receiver of an EUD at the CBSD's cell edge, i.e., at the border of its coverage area where the average signal-to-noise ratio (SINR) or DL throughput that an EUD experiences is just sufficient to provide a minimum throughput or quality of service (QoS). A serving CBSD estimates its coverage threshold by analyzing the DL received power reported by EUDs that are being served—such as reference signal received power (RSRP) in LTE systems. To implement such an analysis, the serving CBSD constructs a histogram from the reported RSRP samples and may use the notion of cut-off fraction (to be discussed) to estimate its coverage threshold. It is to be noted that, in addition to the RSRP, the CBSD may use other parameters based on DL received power of the reference signal such as reference signal received quality (RSRQ), reference signal's signal to interference plus noise ratio (RS-SINR), or channel state information—reference signal (CSI-RS). Without loss of generality, from here onwards we shall use RSRP to describe the proposed solution based on downlink received power.

The ability of a CBSD to estimate its coverage threshold is facilitated by at least some of (but not limited to) the following:
The coverage threshold of a CBSD which can be used by SAS or CxM to calculate the coverage area and determine if it is being interfered or it interferes any other CBSDs;
A set of EUDs that are on the edge of its coverage area (i.e., cell edge); and
The pathloss experienced by an EUD at the cell edge, which may further be used to calibrate the reference propagation model; and
The maximum transmission power that the CBSD can use without interfering any incumbents and other CBSDs.

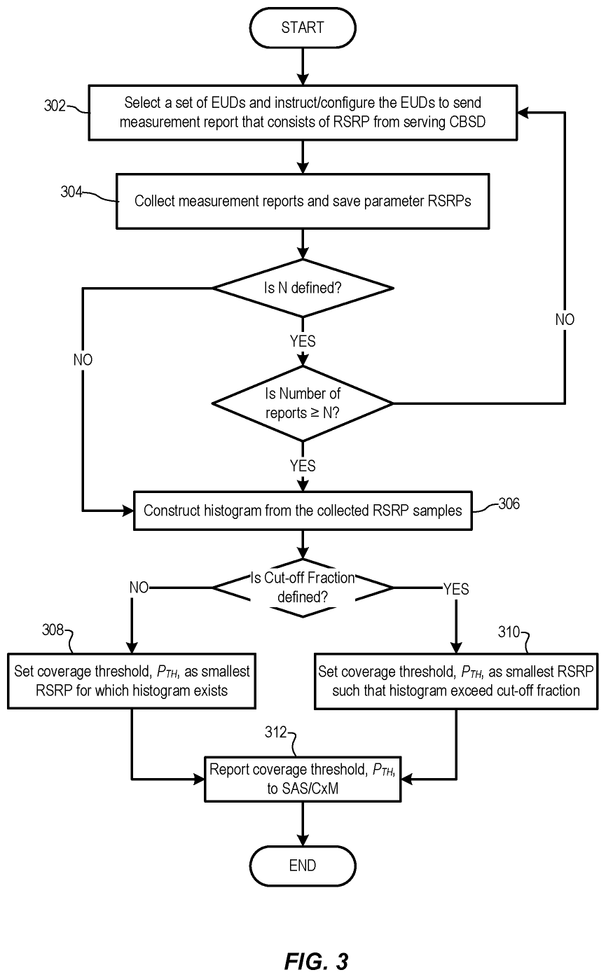

The present technique is based on measurements performed by EUDs that are being served by a CBSD (referred to as a serving CBSD) that intends to determine its coverage threshold. The method comprises the serving CBSD instructing and/or configuring a set of EUDs to measure and report RSRP values from the serving CBSD. The CBSD then analyzes the collected RSRP samples by constructing a histogram to estimate its coverage threshold. Referring to the flow chart of FIG. 3, principle steps that are involved in the present coverage threshold estimation method are described in detail below:

Step 302: Configuring EUD to send measurement report: A serving CBSD 104 or 112 that intends to estimate its coverage threshold configures or instructs a set of EUDs 106, that it is serving, to send measurement reports which consist of RSRP values from the CBSD itself. Such EUDs 106 are scattered around the serving CBSD 104 or 112 as may be seen in FIG. 1. Upon receiving such an instruction from its serving CBSD, an EUD measures the respective RSRP and reports the RSRP with a measurement report to the serving CBSD.

Step 304: Collection of measurement samples: A CBSD may select some or all EUDs and instruct to them to send measurement reports that consist of RSRP measurements of transmissions from the CBSD to EUDs. Furthermore, the CBSD may choose to instruct EUDs periodically or aperiodically at a suitable time, such as during low-traffic or non-busy hours, to send the measurement reports. Note that it is not necessary that the CBSD instruct the same set of EUDs to send a measurement report all the time. Thus, the CBSD may collect RSRP samples from several EUDs over a long interval of time. The reported RSRP may be in a form of bins, such that each bin represents a range of received power.

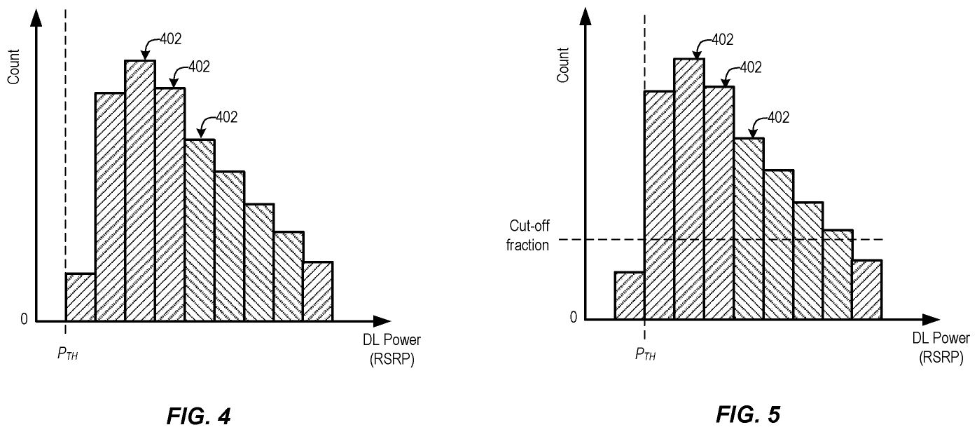

Step 306: Construction of Histogram: The CBSD constructs a histogram of the collected RSRP samples. Whenever, an EUD reports an RSRP, the corresponding bin 402 (FIG. 4) in which the reported RSRP falls is updated. The x-axis of the constructed histogram is comprised of the available RSRP value (mean or maximum or minimum value of the bin), whereas the y-axis is comprised of the number of reported RSRP samples or the fraction of RSRP samples reported in the bins with respect to the total number of reported RSRP samples. Such a histogram is illustrated in FIG. 4. The CBSD may construct such a histogram as soon as it gets the first measurement report or after getting enough samples (which is determined by a predefined threshold, say N). Once a histogram is constructed, a CBSD updates its histogram each time it receives further measurement reports.

Steps 308-310: Estimation of coverage threshold: The CBSD estimates its coverage threshold, denoted as P_{TH} in the figures, by analyzing the constructed histogram. One possible way is by determining (at 308) the smallest RSRP value for which a bin 402 in the histogram exists as shown in FIG. 4. However, as there may be few samples with the smallest RSRP value it may not be practical to determine the coverage threshold based on such a smallest bin. To avoid such a case, the CBSD can determine the coverage threshold by identifying (at 310) the smallest RSRP value for which the fraction, or number, of RSRP samples having the identified smallest value is equal to or more than a predefined cut-off fraction, as shown in FIG. 5. Note that FIG. 4 shows a case for which the cut-off fraction is 0. In another implementation, the coverage threshold may be determined by implementing a fixed margin below the smallest RSRP value. FIG.

Step 312: Report to SAS/CxM: The coverage threshold P_{TH} may be reported by the CBSD to the SAS/CxM in a protocol report message. Alternately, the histogram or a summary thereof may be reported to the SAS/CxM. In another implementation, the histogram data or coverage threshold may be aggregated from more than one CBSD in a network optimization function in the operator's network. In that case, cells are grouped together in some manner and data cells in the same group may be aggregated to report one coverage threshold value for a group of cells.

It is to be noted that, the required decision values, such as the number of EUDs to instruct for a given measurement instance, periodicity of measurement instruction (if applicable), the minimum number of samples required to construct histogram (N, if applicable), cut-off fraction, etc., that are required in the present technique may be either provided by the SAS/CxM or may be decided by CBSD itself.

The proposed solution can be partially implemented in the cloud, such that the serving CBSD collects the measurement samples. The CBSD then may construct the histogram. The CBSD then sends the measurement samples, and/or histogram if applicable, to the entity in the cloud, such as a domain proxy, SAS or CxM or any physical or virtual computing device that can construct a histogram and perform the necessary calculations. If only measurement samples are supplied, the entity in the cloud constructs the histogram of RSRP samples following the process described in the previous section. Thus, the histogram, constructed by either the cloud entity or serving CBSD, is used to estimate the coverage threshold. The estimated coverage threshold may be reported to SAS, CxM, and CBSD if needed.

### ABBREVIATIONS

CBRS: Citizens Broadband Radio Service
CBRS-A: CBRS Alliance
CBSD: Citizens Broadband Radio Service Device
CxM: Coexistence Manager
eNB: Evolved NodeB
EUD: End User Device
FSS: Fixed Satellite Service
GAA: General Authorized Access
GWU: Grandfathered Wireless User
HAAT: Height Above Average Terrain
MBB: Mobile Broadband
PA: Priority Access
PAL: Priority Access License
RSRP: Reference Signal Received Power
RSRQ: Reference Signal Received Quality
SAS: Spectrum Access System
SINR Signal to Interference Plus Noise Ratio
WBS: Wireless Broadband Services
WInnForum: Wireless Innovation Forum
WISP: Wireless Internet Service Provider

Those skilled in the art will recognize improvements and modifications to the embodiments of the present disclosure. All such improvements and modifications are considered within the scope of the concepts disclosed herein.

What is claimed is:

1. A network node of a communications network configured to provide Citizen Broadband Radio Service (CBRS) to at least one end user device (EUD) in a coverage area of the network node, the network node comprising:
at least one processor; and
a memory storing software instructions configured to control the at least one processor to perform steps of:
causing the at least one EUD to report information indicative of a respective reference signal downlink power detected by the at least one EUD; and
determine a respective coverage threshold for the network node based on the information reported by the at least one EUD.

2. The network node as claimed in claim 1, further comprising reporting the respective coverage threshold for the network node to at least one of a Spectrum Access System (SAS) and a co-existence manager (CxM) of the communications network.

3. The network node as claimed in claim 1, wherein causing the at least one EUD to report information indicative of a respective reference signal downlink power comprising transmitting a request to the at least one EUD.

4. The network node as claimed in claim 1, wherein causing the at least one EUD to report information indicative of a respective reference signal downlink power comprising configuring the at least one EUD to report the information indicative of a respective reference signal downlink power detected by the at least one EUD to the network node.

5. The network node as claimed in claim 1, wherein the information indicative of a respective reference signal downlink power comprises any one or more of:
a reference signal received power (RSRP) sample;
a reference signal received quality (RSRQ) sample;
a reference signal-signal to interference plus noise ratio (RS-SINR) sample, and
channel state Information-reference signal (CSI-RS).

6. The network node as claimed in claim 1, wherein determining a respective coverage threshold for the network node based on the information reported by the at least one EUD comprises:
constructing a histogram based on the reported information indicative of the respective reference signal downlink power detected by the at least one EUD;
determining the respective coverage threshold for the network node based on the histogram.

7. The network node as claimed in claim 6, wherein determining the respective coverage threshold for the network node based on the histogram comprises:
identifying a smallest reference signal downlink power for which a bin in the histogram exists; and
setting the respective coverage threshold to a value corresponding to the identified smallest value.

8. The network node as claimed in claim 6, wherein determining the respective coverage threshold for the network node based on the histogram comprises:
identifying a smallest reference signal downlink power value for which a number of samples having the identified smallest reference signal downlink power value is equal to or more than a predefined cut-off fraction; and
setting the respective coverage threshold to a value corresponding to the identified smallest value.

9. A method in network node of a communications network configured to provide Citizen Broadband Radio Service (CBRS) to at least one end user device (EUD) in a coverage area of the network node, the method comprising:
causing the at least one EUD to report information indicative of a respective reference signal downlink power detected by the at least one EUD; and
determining a respective coverage threshold for the network node based on the information reported by the at least one EUD.

10. The method as claimed in claim 9, further comprising reporting the respective coverage threshold for the network node to at least one of a Spectrum Access System (SAS) and a co-existence manager (CxM) of the communications network.

11. The method as claimed in claim 9, wherein causing the at least one EUD to report information indicative of a respective reference signal downlink power comprising transmitting a request to the at least one EUD.

12. The method as claimed in claim 9, wherein causing the at least one EUD to report information indicative of a respective reference signal downlink power comprising configuring the at least one EUD to report the information indicative of a respective reference signal downlink power detected by the at least one EUD to the network node.

13. The method as claimed in claim 9, wherein the information indicative of a respective reference signal downlink power comprises any one or more of:
a reference signal received power (RSRP) sample;
a reference signal received quality (RSRQ) sample;
a reference signal-signal to interference plus noise ratio (RS-SINR) sample, and
channel state Information-reference signal (CSI-RS).

14. The method as claimed in claim 9, wherein determining a respective coverage threshold for the network node based on the information reported by the at least one EUD comprises:
constructing a histogram based on the reported information indicative of the respective reference signal downlink power detected by the at least one EUD;
determining the respective coverage threshold for the network node based on the histogram.

15. The method as claimed in claim 14, wherein determining the respective coverage threshold for the network node based on the histogram comprises:
identifying a smallest reference signal downlink power for which a bin in the histogram exists; and
setting the respective coverage threshold to a value corresponding to the identified smallest value.

16. The method as claimed in claim 15, wherein determining the respective coverage threshold for the network node based on the histogram comprises:
identifying a smallest reference signal downlink power value for which a number of samples having the identified smallest reference signal downlink power value is equal to or more than a predefined cut-off fraction; and
setting the respective coverage threshold to a value corresponding to the identified smallest value.

17. A non-transitory computer readable storage medium comprising software instructions configured to control a network node of a communications network configured to provide Citizen Broadband Radio Service (CBRS) to at least one end user device (EUD) in a coverage area of the network node to implement a process comprising:
causing the at least one EUD to report information indicative of a respective reference signal downlink power detected by the at least one EUD; and
determining a respective coverage threshold for the network node based on the information reported by the at least one EUD.
